(19) United States
(12) Patent Application Publication
(10) Pub. No.: US 2011/0169947 A1
(43) Pub. Date: Jul. 14, 2011

(54) IMAGE IDENTIFICATION USING TRAJECTORY-BASED LOCATION DETERMINATION

(75) Inventors: Arnold Jason Gum, San Diego, CA (US); Lionel Garin, Palo Alto, CA (US)

(73) Assignee: QUALCOMM Incorporated, San Diego, CA (US)

(21) Appl. No.: 12/685,859

(22) Filed: Jan. 12, 2010

(51) Int. Cl. H04N 7/18; H04M 1/00; G01S 19/51

(52) U.S. Cl. 348/135; 455/556.1; 348/E07.085; 342/357.34

(57) ABSTRACT

The subject matter disclosed herein relates to acquiring information regarding a target object using an imaging device of a handheld mobile device.

### BACKGROUND

1. Field

The subject matter disclosed herein relates to acquiring information regarding a target object using an imaging device of a handheld mobile device.

2. Information

Handheld mobile devices that include a digital camera, such as a cell phone or a personal digital assistant (PDA), continue to increase in popularity. Such devices may store a number of photos to be viewed at a later time. Photos may be stored with information regarding the time the photo was taken, pixel size, aperture, and exposure setting, and so on. However, information regarding an object in a photo may be desirable.

### BRIEF DESCRIPTION OF THE FIGURES

Non-limiting and non-exhaustive features will be described with reference to the following figures, wherein like reference numerals refer to like parts throughout the various figures.

FIG. 1 is a schematic diagram showing an image capturing device and a target object, according to an implementation.

FIG. 2 is a schematic diagram of a satellite positioning system (SPS), according to an implementation.

FIG. 3 is a schematic diagram showing an image capturing device directed toward target objects, according to an implementation.

FIG. 4 is a schematic diagram representing a viewfinder image coupled to an image capturing device directed toward target objects, according to an implementation.

FIG. 5 is a schematic diagram representing a captured image that includes target objects, according to an implementation.

FIG. 6 is a flow diagram illustrating a process for acquiring information regarding a target object, according to an implementation.

FIG. 7 is a flow diagram illustrating a process for identifying a target object, according to an implementation.

FIG. 8 is a schematic diagram representing a display, according to an implementation.

FIG. 9 is a schematic diagram of a mobile device capable of sensing its motion and communicating with a wireless network, according to an implementation.

### SUMMARY

In an implementation, a process may include determining an approximate position of a handheld mobile device; capturing an image of one or more target objects using an imaging device, the imaging device fixedly attached to the handheld mobile device; determining one or more angles of rotation of the handheld mobile device relative to the approximate position based, at least in part, on measurements obtained from sensors of the handheld mobile device responsive to the maneuvering; estimating a location of a selected target object selected among the one or more target objects based, at least in part, on the approximate position and the one or more angles of rotation; receiving an identity of the selected target object based, at least in part, on the estimated location of the selected target object and the captured image; and displaying on the handheld mobile device information descriptive of the selected target object based, at least in part, on the received identity. It should be understood, however, that this is merely a particular example of methods disclosed and discussed throughout, and that claimed subject matter is not limited to this particular example.

### DETAILED DESCRIPTION

Reference throughout this specification to “one example”, “one feature”, “an example” or “one feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

Implementations described herein include using a handheld mobile device (HMD) to identify and subsequently receive information regarding a particular target object after selecting the particular target object in a photograph shown in a display coupled to the HMD. For example, such a target object may comprise a building or a statue, just to name a few examples. Using such a display and a user interface of an HMD, a user may select a particular target object among several displayed target objects in a captured image. Upon a selection of a target object, an HMD may go through a process of identifying such a selected target object, as described in detail below.

In a particular implementation, a selection of a particular target object may result in an HMD acquiring information regarding the particular target object from a remote source if the HMD does not already maintain such information in a memory of the HMD. Such a remote source, such as a land-based base station for example, may be used to identify a target object. Such a remote source may comprise a database that includes target object information produced and/or maintained by a service that determines which objects (e.g., target objects) may be of interest to users that subscribe to such a service, for example. Such information may comprise facts regarding a target object and/or a history of a target object. At least a portion of such information may be shown in a display coupled to an HMD, though claimed subject matter is not so limited.

To illustrate a particular example, a number of large museums may provide (e.g., for a fee) a specialized handheld device configured to display or audibly recite information regarding a particular object of art while such a device is in close proximity to such an individual object of art. In such a case, a museum may provide such information via wireless signals transmitted near the individual object of art. In an implementation of an HMD as described above, however, such a specialized handheld device provided by a museum may not be able to provide information about such objects of art. Instead, a user's personal HMD (e.g., a cell phone) may be used to gather information without interaction with a museum since such information may be provided independently of a museum. For example, such an HMD may wirelessly communicate, as explained in detail below, with a server that maintains a database of objects of art to identify and/or gather information regarding a selected particular object of art. In such a case, a user may desire information regarding a particular object of art, at which time the user may capture an image of such an object, and select the image of the object in a display of the HMD. In a particular implementation, the HMD may already store information regarding the selected object, otherwise the HMD may transmit a request to a base-station to identify the object and to provide information regarding the object. Accordingly, the HMD may then receive from the base-station the requested information, which the HMD may then display to the user. Of course, details of such a particular HMD are merely examples, and claimed subject matter is not so limited.

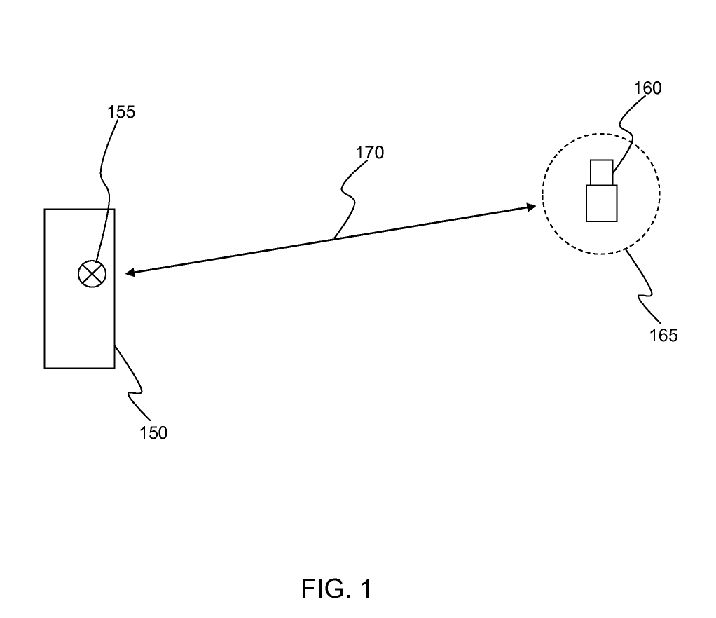

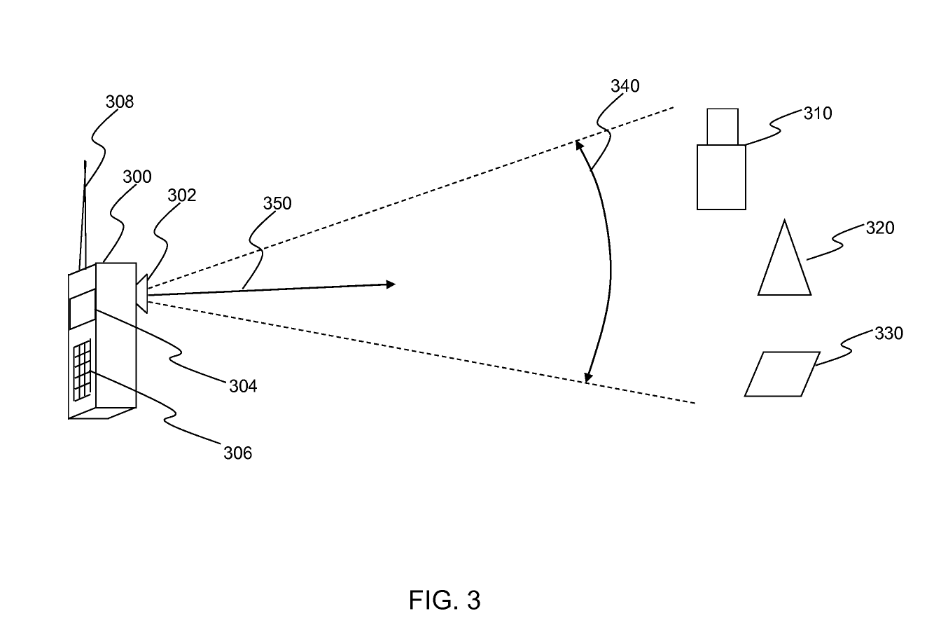

FIG. 1 is a schematic diagram showing an HMD 150 and a target object 160, according to an implementation. Such an HMD may include an image capturing device to capture an image of target object 160, for example. Information regarding target object 160 may be acquired by using an image capturing device fixedly attached to HMD 150. For example, such an image capturing device may be positioned (aimed) to capture an image of target object 160 while position 155 of HMD 150 may be determined using any one of several available positioning techniques, as described below. Additionally, one or more angles of rotation of HMD 150 may be determined. Location of a selected target object may be estimated based, at least in part, on the determined position and/or one or more angles of rotation of the HMD. Such angles of rotation, for example, may be used to estimate a displacement 170 between HMD 150 and target object 160. Together, position 155 and estimated displacement 170 may be used to estimate a location of target object 160. Using such an estimated location and captured image of target object 160, an identity of the selected target object may be determined HMD 150 may then acquire information regarding the identified target object 160. HMD 150 may include a display device (FIG. 3) to display such an identified target object and/or associated information.

As an example of such an implementation, a user may aim a camera included in a cellular phone toward a particular building for which the user desires information. Such a cellular phone may be enabled to determine its location using one or more positioning technologies. Such a cellular phone may also be enabled to determine one or more of the cellular phone's angles of rotation with respect to a particular reference direction. For example, a user located at a corner of Broadway and Sylvan Avenue in Kearny, N.J. may be directing a camera ten degrees west of north while aiming the camera at a particular building. If a user takes a photo of the particular building, such a position and/or angles of rotation of a cellular phone that includes the camera may be recorded with the photo. Using such position information, one or more angles of rotation, and/or an image recognition process applied to an image of the particular building, an identity of the particular building may be determined. Using such identification, information regarding the particular building may be displayed. A cellular phone may include such information and/or such information may be provided wirelessly from a land-based base station in response to a request for such information from the cellular phone. Of course, such details of acquiring information regarding a target object are merely examples, and claimed subject matter is not so limited.

In an implementation, position information descriptive of a position of an HMD may be provided to an HMD by a user and/or determined using any one of several available positioning techniques. A list of such positioning techniques may include satellite positioning system (SPS), a Personal Area Network (PAN), a Local Area Network (LAN), a Wide Area Network (WAN), Ultra-wideband (UWB), AFLT, digital TV, a wireless repeater, RFID, a radio-location beacon, cell tower ID, and/or Bluetooth, just to name a few examples. Some positioning techniques may provide less precise position information compared to other positioning techniques. Less precise position information, for example, may pinpoint a location of an HMD only to within a relatively large area, such as a building, a city block, a state, and so on. To illustrate, position information may establish that an HMD is located in the city of Kearny, or that the HMD is located in or near a subway station in San Francisco's financial district. In such cases of relatively imprecise position information, an HMD may utilize additional information, such as manually entered user inputs, sensor information, and/or image recognition techniques, to determine more precise position information. Such improved position information may then be used to determine an identity of a target object captured in an image by an HMD at such a position. Of course, such details of acquiring position information are merely examples, and claimed subject matter is not so limited.

In another implementation, a user may maneuver an HMD to direct a light beam onto a target object to produce an illuminated spot on the target object. An HMD may subsequently detect such an illuminated spot in a captured image of the target object. Accordingly a target object may be selected and further identified based, at least in part, on a detected illuminated spot. For example, a captured image may comprise multiple target objects, wherein an HMD may determine a selected target object by detecting an illuminated spot on a particular target object.

In another implementation, a user may maneuver an HMD to direct a range-finding beam onto a target object. Such an HMD may include an emitter and a receiver to emit and receive sound, light, IR and/or RF energy, a time module to determine a propagation time of the emitted energy as it travels to and from the target object, and/or a processor to determine a distance to the target object. In another implementation, a user may direct an at least one range-finding beam onto a target object so that a divergence of the at least one range-finding beam may be determined. From a determined divergence, a distance to the target object may be determined. For example, a larger spot size on a target object may imply that the target object is farther away than for a smaller spot size. Accordingly, an identity of a selected target object may be determined based, at least in part, on a location and/or orientation of the HMD, and a determined distance of the target object from the HMD measured using any one of several techniques. Of course, such a process of using a distance to identify a target object is merely an example, and claimed subject matter is not so limited.

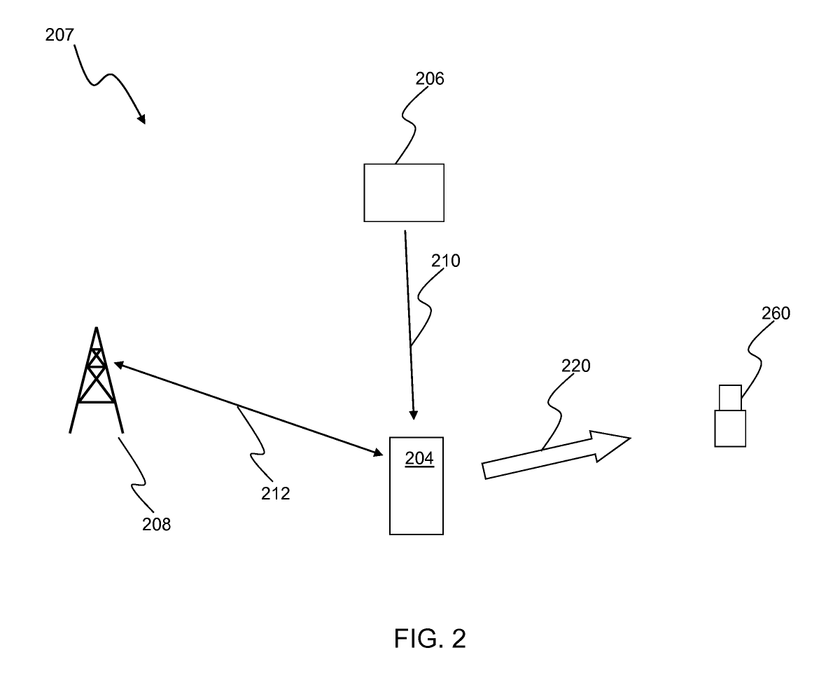

FIG. 2 shows a system 207 of components that may communicate with one another to identify a target object, according to an implementation. In particular, an HMD 204 may comprise any one of a variety of mobile receivers capable of receiving satellite navigation signals 210 and capable of transmitting/receiving wireless communication signals 212 to/from a base station 208. HMD 204 may also have visual contact with a target object 260. Signals 210, for example, may be transmitted from reference stations such as satellite vehicles (SVs) 206 and/or from terrestrial locations such as land-based beacons or base stations 208. HMD 204 may comprise a mobile phone, a handheld navigation receiver, and/or a personal digital assistant (PDA), just to name a few examples. As mentioned above, HMD 204 may employ any of several techniques to compute its position. In a particular implementation, such a positioning technique may be based, at least in part, on wireless signals 210 and/or wireless signals 212 received from satellites 206 and/or land-based base stations 208, respectively. In some implementations, HMD 204 may integrate both an SPS receiver and a wireless communication device for voice and/or data communication. Thus, although the specific example of an SPS system may be described herein, such principles and techniques may be applicable to other satellite positioning systems or terrestrial positioning systems such as a wireless network. Of course, such details of system 207 are merely examples, and claimed subject matter is not so limited.

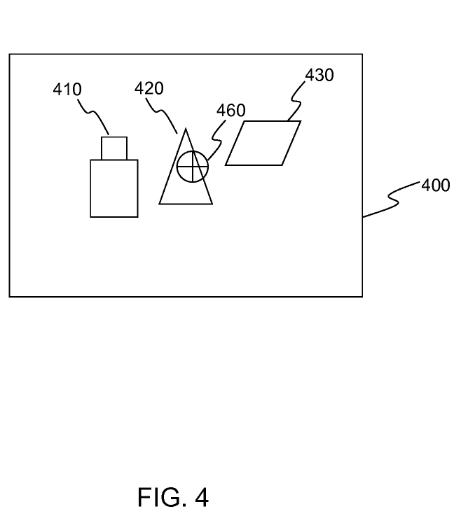

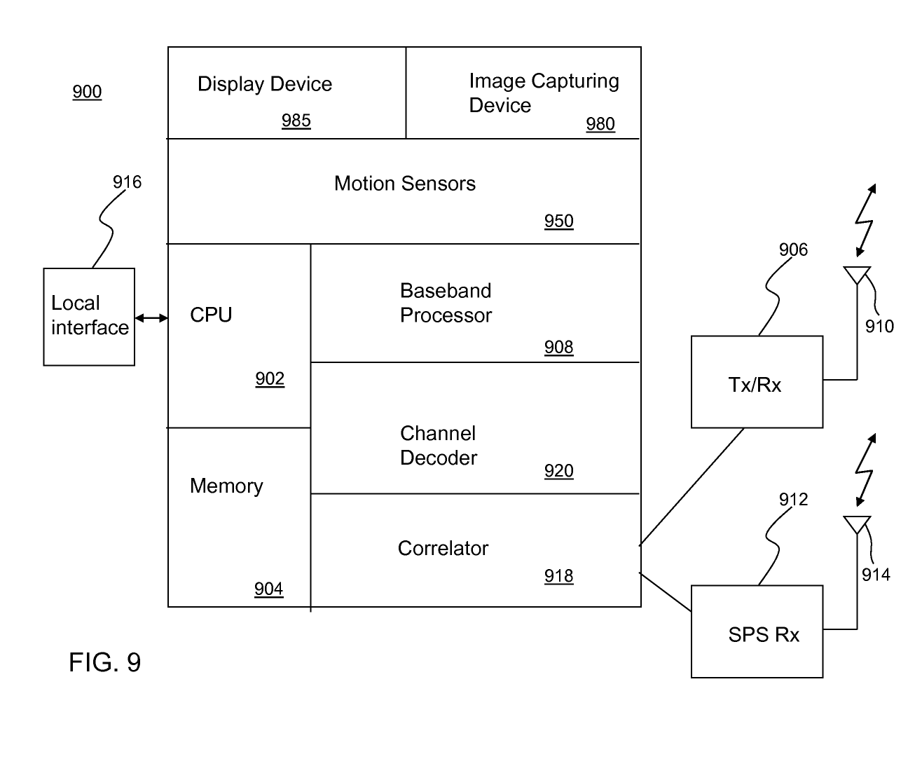

FIG. 3 is a schematic diagram showing an HMD 300 directed toward target objects 310, 320, and/or 330, according to an implementation. HMD 300 may include an image capturing device, 302, a display 304, a keypad 306, and/or an antenna 308. Such an image capturing device (e.g., a camera) may display a viewfinder image and/or a captured image in display 304. HMD 300 may include a special purpose processor (FIG. 9) to host one or more applications, as described in greater detail below. HMD 300 may include one or more user interfaces such as keypad 306 and/or a display 304, which may comprise a touch screen for example. Antenna 308 may comprise a portion of a transmitter/receiver (FIG. 9) used by HMD 300 to transmit and/or receive various signals, such as from a positioning system, and/or to/from a base station. In an application, HMD 300 may be directed or aimed so that a captured image is centered on any particular target object. Display 304 used as a viewfinder for image capturing device 300 may include a viewfinder (FIG. 4) that defines an image boundary or viewing angle 340 and an image center line 350, which may assist a user in determining which portion of a scene is to be captured as an image. For example, multiple target objects 310, 320, and/or 330 may be included within viewing angle 340, and image capturing device 300 may be aimed so that target object 320 is centered in a captured image. Such target objects may comprise people, buildings, statues, lakes, mountains, and/or landmarks, just to name a few examples. Though such target objects may be captured in an image, not all target objects, such as people for example, may be identified by processes and/or techniques described herein. For example, a person may pose next to the Lincoln Memorial for a photo (a captured image). Such a monument may be identified, as described below, whereas the person, and other objects within a captured image, need not be identified. A process for identifying which target object is to be identified will be described in detail below.

FIG. 4 is a schematic diagram representing a viewfinder image 400 of an image capturing device, such as image capturing device 300, directed toward target objects 410, 420, and 430, according to an implementation. As mentioned above, such a viewfinder image may be shown by display 304. Viewing angle 340 may define edges of view finder image 400. Center line 350 may define image center 460, which may comprise cross-hairs, a circle, and/or other symbol or configuration that indicates an image center to a user, for example. Viewfinder image 400 may include photographic information (not shown) such as light level, shutter speed, number of photos taken, and so on. Of course, details of such a viewfinder image are merely examples, and claimed subject matter is not so limited.

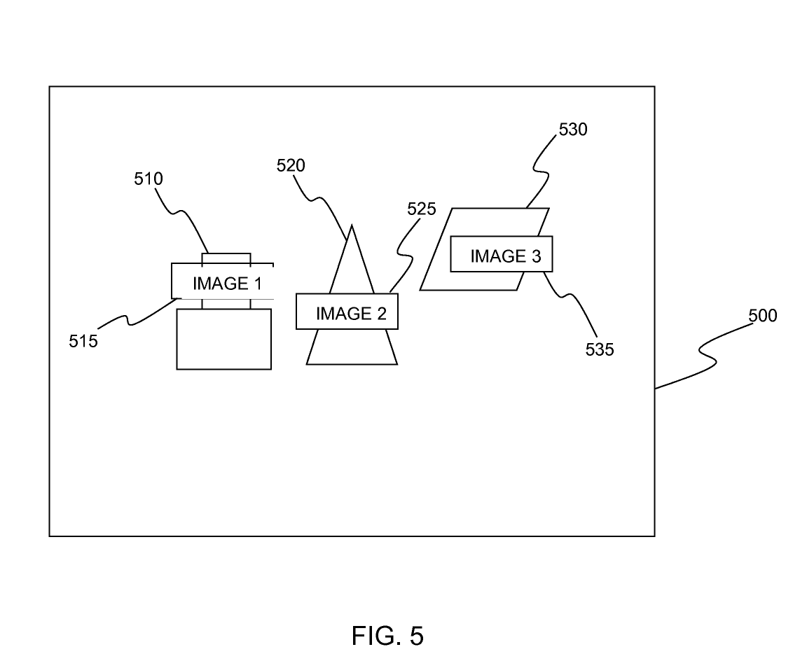

FIG. 5 is a schematic diagram representing a captured image 500 that includes target objects 510, 520, and 530, according to an implementation. Such target objects may be labeled, for example, by overlaid and/or superimposed object designators such as labels 515, 525, and/or 535. For example, such labels may comprise semi-transparent numbers and/or letters superimposed on target objects. Such labeling may provide a way for a user to select a particular target object among a plurality of target objects. In one particular implementation, an HMD may determine which target objects included in a captured image are identifiable, and thus place labels over such identified target objects. An HMD may analyze a captured image using an image recognition technique to determine which portions of the captured image comprise a target object and which portions comprise merely background images. For example, a captured image may include three adjacent statues in a central region of a captured image, surrounded by background images. In such a case, image recognition techniques may be used to determine which portions of a captured image are target objects (e.g., the statues) and which portions are merely background imagery. If such target objects are successfully identified during such a process, then an HMD may label such target objects, as described above. In another implementation, in an absence of such labels, a user may select a particular target object via a pointing device, such as a mouse and/or touch pad, for example, to navigate an icon or symbol to a particular target object in the a displayed captured image to select the particular target objects. In yet another implementation, an HMD may display a selection indicator or symbol in a display device to indicate which target object among multiple target objects in the displayed captured image is currently selected. Such indication may comprise highlighting a current selection by brightening the selection compared to other portions of the captured image, displaying a frame around the selection, and/or increasing the image size of the selection, just to name a few examples. A user may then toggle a position of the selection indicator to jump among the target objects in the displayed captured image. For example, a user may press a key once for each selection jump from one target object to a next target object. Accordingly, a user may then select one or more target objects in a displayed captured image based, at least in part, on a position of such a selection indicator.

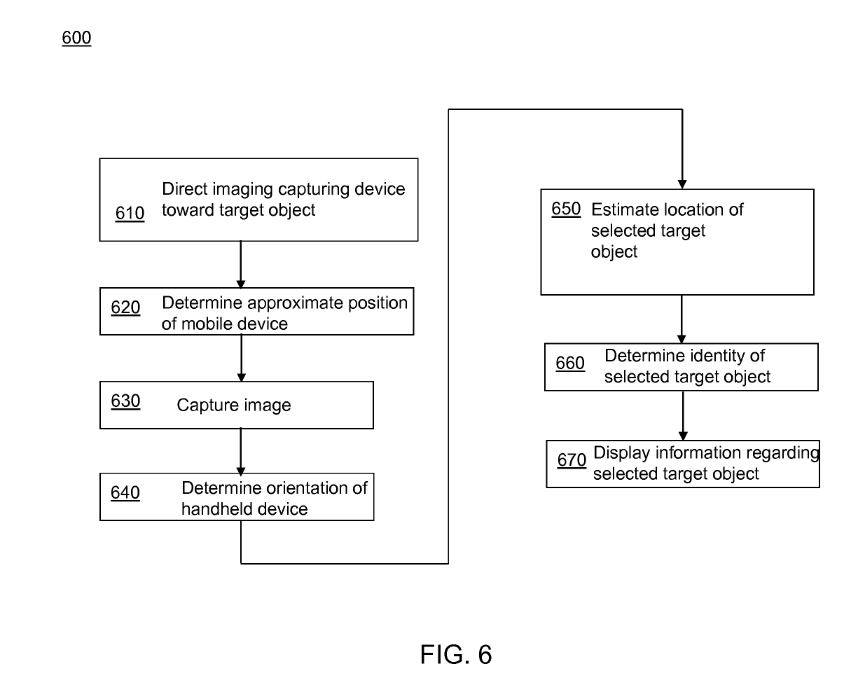

FIG. 6 is a flow diagram of a process 600 for acquiring information regarding a target object, according to an implementation. At block 610, a user may direct an imaging capturing device toward a target object for which the user desires information. A user may aim an image capturing device so that such a target object is at least approximately centered in a viewfinder image, as indicated by image center 460, for example. Alternatively, a user may select such a target object among multiple target objects subsequent to capturing an image, as described above for example. At block 620, a HMD may determine its position at least approximately. Such a determination may be made from time to time, continually, periodically, or consequent to capturing an image, as at block 630, for example. Similarly, at block 640, an HMD may determine its orientation from time to time, continually, periodically, or consequent to capturing an image, as at block 630, for example. In one particular implementation, such an HMD may comprise one or more sensors to determine one or more angles of orientation. For example, such sensors may comprise an accelerometer, magnetometer, compass, pressure sensor, and/or a gyro, just to name a few examples. Accordingly, such sensors may measure direction, elevation, inclination, and so on of an HMD during an image capturing process. Such sensor information may be stored in a memory and associated with a captured image, for example. Of course, details of such sensors are merely examples, and claimed subject matter is not so limited.

At block 650, a location of a selected target object may be estimated based, least in part, on determined position and determined one or more angles of rotation of an HMD that captured an image of the selected target. For example, an HMD may determine that a selected target object is located twenty degrees west of north of an HMD at an incline of ten degrees above horizontal. Such an HMD may also determine its position, such as a geodetic position determined via SPS technology, for example. In one particular implementation, angles of rotation may be used to estimate a displacement between an HMD and a target object. Together, a determined HMD position and such an estimated displacement may be used to estimate a location of a target object. At block 660, using such a location estimate and/or an image recognition process, an identity of a selected target object may be determined, as described in further detail below. At block 670, information regarding an identified selected target object may be shown in a display of an HMD. Of course, such details of determining an identity of a target object are merely examples, and claimed subject matter is not so limited.

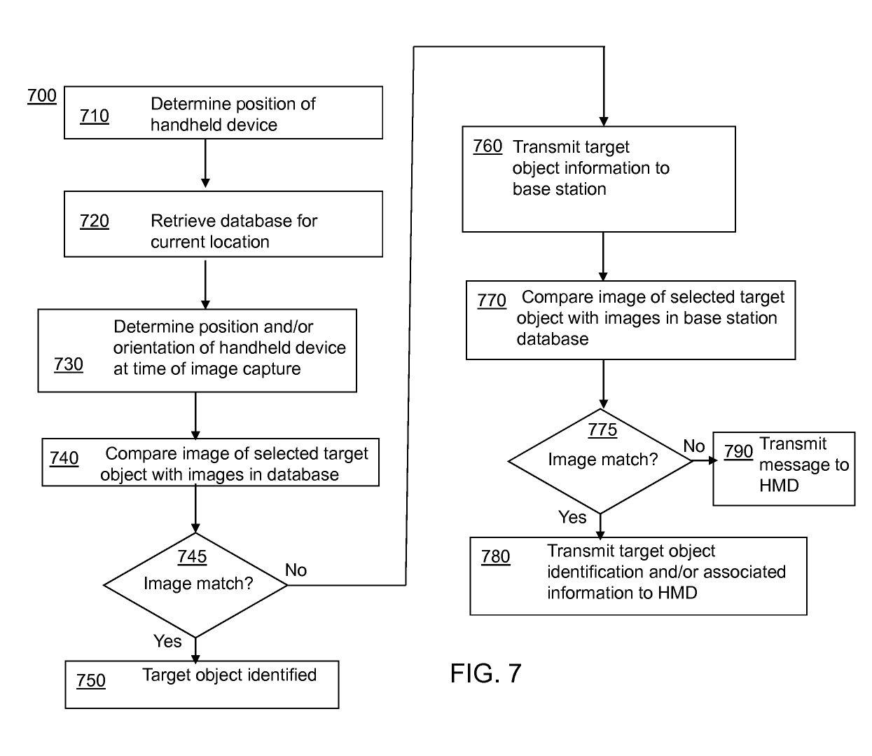

FIG. 7 is a flow diagram of a process 700 for identifying a target object in a captured image, according to an implementation. Such a process may comprise a process performed at block 660 in FIG. 6, for example. At block 710, a position of an HMD may be determined using any one of several techniques identified above, for example. Such a position determination may be approximate. For example, for process 700, determining a city, county, and/or region where an HMD is located may be sufficient. Alternatively, a user may manually provide a location of an HMD, by entering a location via a touch-screen, keypad, or the like.

At block 720, an HMD may request a database of identification information from a base station or other such land-based entity based, at least in part, on such a position determination and/or user input. Such a database may include information regarding target objects in a region surrounding a current location of the HMD. In one implementation, as mentioned above, such information may be produced and/or maintained by a service that determines which objects may be of interest to users that subscribe to such a service. For example, a user arriving in New York City may carry an HMD that may download information regarding target objects within a one kilometer radius of the HMD. The size of such a radius may depend on the number of target objects within such a radius and/or memory capacity of the HMD, though claimed subject matter is not so limited. For example, a radius of one kilometer in New York City may include the same number of target objects (e.g., objects of interest that have been recorded into a database) as a radius of one hundred kilometers in a desert region of Arizona. An HMD may store such information of a current HMD location to be used for target object identification. Identification information may comprise image information to be used for an image recognition process that may be performed by an HMD to identify a selected target object. One such image recognition process is described in Fan, U.S. Patent Application Publication No. US2007/0009159, for example. For example, such information may comprise images of landmarks, buildings, statues, and/or signs, for example, which are located near an HMD, accordingly to a position determination. In one particular implementation, an HMD may request such information from time to time, periodically, consequent to a substantial change in location of the HMD (e.g., arriving at an airport), and/or consequent to capturing an image. Accordingly, such an HMD may continually store such information regarding the HMD's present location and may purge outdated information regarding a region where the HMD is no longer located. Such a memory update/purge process may accommodate a limited memory size of an HMD, for example.

At block 730, though a position of an HMD may have been determined earlier, as at block 710, the HMD may again perform a determination of its position consequent to capturing an image (taking a photo) with the HMD. In addition, orientation, such as one or more angles of an HMD relative to a reference direction, as described above, may be determined. If, however, an HMD already contains sufficiently current location information acquired from a recent position determination, then block 730 may be skipped and/or modified so that orientation is determined at a time of image capture.

At block 740, features of an image of a selected target object may be compared with features of one or more images stored in a memory of an HMD during an image recognition process. At block 745, if a matching image is found, then a target object may be identified. For example, a selected target object may comprise an image of the Statue of Liberty. One or more features of such an image may be compared to a database of features of multiple stored images of landmarks and other objects in a region of New York City. If an image of a selected target object matches an image of a known entity (Statue of Liberty in the present example), then the selected target object may be identified, and such a database may provide information regarding the target object. On the other hand, if no match is found, the process 700 may proceed to block 760, where a larger database may be accessed. In a particular implementation, an HMD may transmit at least a portion of an image of a selected target object to a land-based station or other entity remote from the HMD and request that an image recognition process be performed at such a land-based station. Of course, such a larger database of image information may be located at another mobile device, and claimed subject matter is not limited to a land-based entity.

At block 770, features of an image of a selected target object may be compared with features of one or more images stored in a memory of base station during an image recognition process. At block 775, if a matching image is found, then a target object may be identified. Accordingly, a base station may transmit information associated with the identified target object to an HMD. On the other hand, if no match is found, at block 790, a base station may transmit a message to an HMD indicating that a target identification process was not successful. Of course, such details of an identification process are merely examples, and claimed subject matter is not so limited.

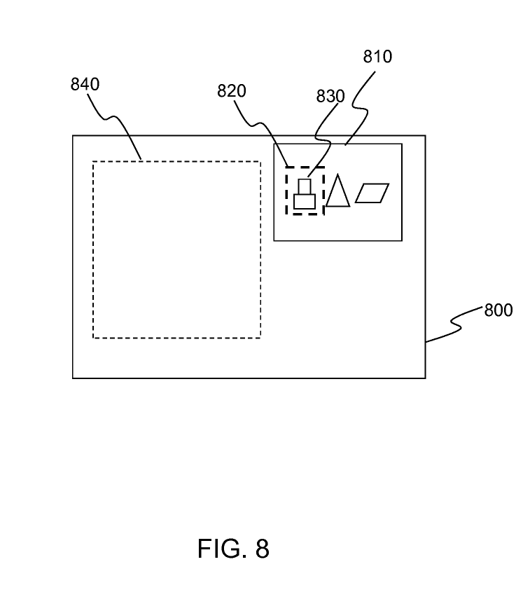

FIG. 8 is a schematic diagram representing a display 800, according to an implementation. An HMD may comprise such a display, which may include a thumbnail 810 of a captured image, graphics 820 to indicate a selected target object 830, and/or a window 840 to display information regarding selected target object 830. Such a thumbnail 810, comprising a reduced-size version of a captured image, may occupy less display area compared to a full-size captured image, thus allowing display 800 to include area for displaying window 840. In such a fashion, a display may provide a user with information regarding a target object displayed as text in window 840 while displaying selected target object 830. Of course, such a display is merely an example, and claimed subject matter is not so limited.

FIG. 9 is a schematic diagram of a device capable of communication with a wireless network and sensing its motion, according to one implementation. Such a device may include an image capturing device. In a particular implementation, an HMD, such as HMD 104 shown in FIG. 1, may comprise a device 900 that is capable of processing SPS signals received at an antenna 914 for determining pseudorange measurements and communicating with a wireless communication network through antenna 910. Here, a radio transceiver 906 may be adapted to modulate an RF carrier signal with baseband information, such as data, voice, and/or SMS messages, onto an RF carrier, and demodulate a modulated RF carrier to obtain such baseband information. Antenna 910 may be adapted to transmit a modulated RF carrier over a wireless communications link and receive a modulated RF carrier over a wireless communications link.

Baseband processor 908 may be adapted to provide baseband information from central processing unit (CPU) 902 to transceiver 906 for transmission over a wireless communications link. Here, CPU 902 may obtain such baseband information from a local interface 916 which may include, for example, environmental sensory data, motion sensor data, altitude data, acceleration information (e.g., from an accelerometer), proximity to other networks (e.g., ZigBee, Bluetooth, WiFi, peer-to-peer). Such baseband information may also include position information such as, for example, an estimate of a location of device 900 and/or information that may be used in computing same such as, for example, pseudorange measurements, and/or ES position information. Such ES position information may also be received from user input, as mentioned above. CPU 902 may be adapted to estimate a trajectory of device 900 based at least in part on measured motion data. CPU 902 may also be able to compute candidate trajectories. Channel decoder 920 may be adapted to decode channel symbols received from baseband processor 908 into underlying source bits.

SPS receiver (SPS Rx) 912 may be adapted to receive and process transmissions from SVs, and provide processed information to correlator 918. Correlator 918 may be adapted to derive correlation functions from the information provided by receiver 912. Correlator 918 may also be adapted to derived pilot-related correlation functions from information relating to pilot signals provided by transceiver 906. This information may be used by device acquire a wireless communications network.

Memory 904 may be adapted to store machine-readable instructions which are executable to perform one or more of processes, examples, implementations, or examples thereof which have been described or suggested. CPU 902, which may comprise a special purpose processor, may be adapted to access and execute such machine-readable instructions. However, these are merely examples of tasks that may be performed by a CPU in a particular aspect and claimed subject matter in not limited in these respects. Further, memory 904 may be adapted to store one or more predetermined candidate trajectories, wherein CPU 902 may be adapted to determine a location of device 900 based, at least in part, on a comparison of an estimated trajectory with the one or more predetermined candidate trajectories. In a particular implementation, CPU 902 may be adapted to reduce a number of the one or more predetermined candidate trajectories based at least in part on ES position information.

In an implementation, motion sensor 950 may include one or more transducers to measure a motion of device 900. Such transducers may include an accelerometer, a compass, a pressure sensor, and/or a gyro, for example. Such a motion of device 900 may include a rotation and/or a translation. Measurements of one or more such motions may be stored in memory 904 so that stored measurements may be retrieved for use in determining a trajectory of device 900, as in explained above, for example.

In an implementation, image capturing device 980 may comprise a camera including a charge coupled device (CCD) array and/or a CMOS array of light sensors, focusing optics, a viewfinder, and/or interfacing electronics to communicate with CPU 902 and memory 904, for example. Display device 985 may comprise a liquid crystal display (LCD) that, in some implementations, may be touch sensitive to provide means for user interaction. Display device 985 may operate as a viewfinder for image capturing device 980, though claimed subject matter is not so limited. Images may be stored in memory 904 so that stored images may be retrieved as a selected target object, as described above.

Methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

For a firmware and/or software implementation, methodologies may be implemented with modules (e.g., procedures, functions, and so on) that perform the functions described herein. Any machine-readable medium tangibly embodying instructions may be used in implementing the methodologies described herein. For example, software codes may be stored in a memory, for example the memory of a mobile station, and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

An entity such as a wireless terminal may communicate with a network to request data and other resources. A mobile device (MD), including a cellular telephone, a personal digital assistant (PDA), or a wireless computer are just a few examples of such an entity. Communication of such an entity may include accessing network data, which may tax resources of a communication network, circuitry, or other system hardware. In wireless communication networks, data may be requested and exchanged among entities operating in the network. For example, an HMD may request data from a wireless communication network to determine the position of the HMD operating within the network: data received from the network may be beneficial or otherwise desired for such a position determination. However, these are merely examples of data exchange between an HMD and a network in a particular aspect, and claimed subject matter in not limited in these respects.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
determining an approximate position of a handheld mobile device;
capturing an image of one or more target objects using an imaging device, said imaging device fixedly attached to said handheld mobile device;
determining one or more angles of rotation of said handheld mobile device relative to said approximate position based, at least in part, on measurements obtained from sensors of said handheld mobile device responsive to said maneuvering;
estimating a location of a selected target object selected among said one or more target objects based, at least in part, on said approximate position and said one or more angles of rotation;
receiving an identity of said selected target object based, at least in part, on said estimated location of said selected target object and said captured image; and
displaying on said handheld mobile device information descriptive of said selected target object based, at least in part, on said received identity.

2. The method of claim 1, further comprising:
overlaying one or more object designators on said captured image; and
selecting said selected target object based on a selection of said one or more object designators.

3. The method of claim 2, wherein said one or more object designators respectively overlay corresponding target objects among said one or more target objects.

4. The method of claim 1, further comprising:
comparing one or more features of said captured image with one or more features of a plurality of stored images.

5. The method of claim 4, wherein said comparing said one or more features of said captured image with one or more features of said plurality of stored images further comprises:
transmitting at least a portion of said captured image to a location comprising a memory that stores said plurality of stored images, wherein said location is remote from said mobile device.

6. The method of claim 1, wherein said determining said approximate position of said handheld mobile device is based, at least in part, on Near-Field Communication (NFC) signals, WiFi signals, Bluetooth signals, Ultra-Wideband (UWB) signals, Wide Area Network (WAN) signals, digital TV signals, and/or cell tower ID.

7. The method of claim 1, wherein said determining said approximate position of said handheld mobile device is based, at least in part, on acquisition of one or more satellite positioning system signals at the mobile device.

8. The method of claim 1, wherein said determining said approximate position of said handheld mobile device is based, at least in part, on user input.

9. The method of claim 1, further comprising:
maneuvering said handheld mobile device to direct a light beam onto said target object to produce an illuminated spot on said target object;
detecting said illuminated spot in said captured image; and
further determining an identity of said target object based, at least in part, on said detected illuminated spot.

10. The method of claim 1, further comprising:
directing a range-finding beam onto said target object;
measuring a travel time of said range-finding beam;
determining a distance to said target object based, at least in part, on said travel time; and
further determining an identity of said target object based, at least in part, on said distance.

11. The method of claim 1, further comprising:
directing an at least one range-finding beam onto said target object;
measuring a divergence of said at least one range-finding beam;
determining a distance to said target object based, at least in part, on said divergence; and
further determining an identity of said target object based, at least in part, on said distance.

12. The method of claim 1, wherein said sensors comprise an accelerometer, magnetometer, compass, pressure sensor, and/or a gyro.

13. An apparatus comprising:
means for determining an approximate position of a handheld mobile device;
means for capturing an image of one or more target objects using an imaging device fixedly attached to said handheld mobile device;
means for determining one or more angles of rotation of said handheld mobile device relative to said approximate position based, at least in part, on measurements obtained from sensors of said handheld mobile device responsive to said maneuvering;
means for estimating a location of a selected target object selected among said one or more target objects based, at least in part, on said approximate position and said one or more angles of rotation;
means for receiving an identity of said selected target object based, at least in part, on said estimated location of said selected target object and said captured image; and
means for displaying on said handheld mobile device information descriptive of said selected target object based, at least in part, on said determined identity.

14. The apparatus of claim 13, further comprising:
means for overlaying one or more object designators on said captured image; and
means for selecting said selected target object based on a selection of said one or more object designators.

15. The apparatus of claim 14, wherein said one or more object designators respectively overlay corresponding target objects among said one or more target objects.

16. The apparatus of claim 13, further comprising:
means for comparing one or more features of said captured image with one or more features of a plurality of stored images.

17. The apparatus of claim 16, wherein said means for comparing said one or more features of said captured image with one or more features of said plurality of stored images further comprises:
means for transmitting at least a portion of said captured image to a location comprising a memory that stores said plurality of stored images, wherein said location is remote from said mobile device.

18. The apparatus of claim 13, wherein said means for determining said approximate position of said handheld mobile device is based, at least in part, on Near-Field Communication (NFC) signals, WiFi signals, Bluetooth signals, Ultra-Wideband (UWB) signals, Wide Area Network (WAN) signals, digital TV signals, and/or cell tower ID.

19. The apparatus of claim 13, wherein said means for determining said approximate position of said handheld mobile device is based, at least in part, on acquisition of one or more satellite positioning system signals at the mobile device.

20. The apparatus of claim 13, wherein said means for determining said approximate position of said handheld mobile device is based, at least in part, on user input.

21. The apparatus of claim 13, further comprising:
means for maneuvering said handheld mobile device to direct a light beam onto said target object to produce an illuminated spot on said target object;
means for detecting said illuminated spot in said captured image; and
means for further determining an identity of said target object based, at least in part, on said detected illuminated spot.

22. The apparatus of claim 13, further comprising:
means for directing a range-finding beam onto said target object;
means for measuring a travel time of said range-finding beam;
means for determining a distance to said target object based, at least in part, on said travel time; and
means for further determining an identity of said target object based, at least in part, on said distance.

23. The apparatus of claim 13, wherein said sensors comprise an accelerometer, magnetometer, compass, pressure sensor, and/or a gyro.

24. A mobile device comprising:
a receiver to receive RF signals;
an imaging device to capture an image of one or more target objects;
one or more sensors to measure one or more angles of rotation of said mobile device; and
a special purpose computing device adapted to operate in an RF environment to:
determine an approximate position of said mobile device based, at least in part, on said RF signals;
estimate a location of a selected target object selected among said one or more target objects based, at least in part, on said approximate position and said one or more angles of rotation;
receive an identity of said selected target object based, at least in part, on said estimated location of said selected target object and said captured image; and
process information for display on said mobile device descriptive of said selected target object based, at least in part, on said determined identity.

25. The mobile device of claim 24, wherein said special purpose computing device is further adapted to operate in an RF environment to:
overlay one or more object designators on said captured image; and
receive a selection of said selected target object based on a selection of said one or more object designators.

26. The mobile device of claim 25, wherein said one or more object designators respectively overlay corresponding target objects among said one or more target objects.

27. The mobile device of claim 24, wherein said special purpose computing device is further adapted to operate in an RF environment to:
compare one or more features of said captured image with one or more features of a plurality of stored images.

28. The mobile device of claim 27, wherein said special purpose computing device is further adapted to operate in an RF environment to compare said one or more features of said captured image with one or more features of said plurality of stored images by transmitting at least a portion of said captured image to a location comprising a memory that stores said plurality of stored images, wherein said location is remote from said mobile device.

29. The mobile device of claim 24, wherein said special purpose computing device is further adapted to operate in an RF environment to determine said approximate position of said handheld mobile device based, at least in part, on Near-Field Communication (NFC) signals, WiFi signals, Bluetooth signals, Ultra-Wideband (UWB) signals, Wide Area Network (WAN) signals, digital TV signals, and/or cell tower ID.

30. The mobile device of claim 24, wherein said special purpose computing device is further adapted to operate in an RF environment to determine said approximate position of said handheld mobile device based, at least in part, on acquisition of one or more satellite positioning system signals at the mobile device.

31. The mobile device of claim 24, wherein said special purpose computing device is further adapted to operate in an RF environment to determine said approximate position of said handheld mobile device based, at least in part, on user input.

32. The mobile device of claim 24, wherein said special purpose computing device is further adapted to operate in an RF environment to:
detect an illuminated spot in said captured image of said target object produced by a light beam emitted from said mobile device; and
further determine an identity of said target object based, at least in part, on said detected illuminated spot.

33. The mobile device of claim 24, wherein said special purpose computing device is further adapted to operate in an RF environment to:
measure a travel time of a range-finding beam emitted from said mobile device to said target object;
determine a distance to said target object based, at least in part, on said travel time; and
further determine an identity of said target object based, at least in part, on said distance.

34. The mobile device of claim 24, wherein said sensors comprise an accelerometer, magnetometer, compass, pressure sensor, and/or a gyro.

35. An article comprising: a storage medium comprising machine-readable instructions stored thereon which, if executed by a special purpose computing device, are adapted to enable said special purpose computing device to:
determine an approximate position of a handheld mobile device;
capture an image of one or more target objects using an imaging device fixedly attached to said handheld mobile device;
determine one or more angles of rotation of said handheld mobile device relative to said approximate position based, at least in part, on measurements obtained from sensors of said handheld mobile device responsive to said maneuvering;
estimate a location of a selected target object selected among said one or more target objects based, at least in part, on said approximate position and said one or more angles of rotation;
determine an identity of said selected target object based, at least in part, on said estimated location of said selected target object and said captured image; and
obtain information for display on said handheld mobile device descriptive of said selected target object based, at least in part, on said determined identity.

36. The method of claim 35, wherein said machine-readable instructions, if executed by said special purpose computing device, are further adapted to:
overlay one or more object designators on said captured image; and
select said selected target object based on a selection of said one or more object designators.

37. The method of claim 36, wherein said one or more object designators respectively overlay corresponding target objects among said one or more target objects.

38. The method of claim 35, wherein said machine-readable instructions, if executed by said special purpose computing device, are further adapted to:
compare one or more features of said captured image with one or more features of a plurality of stored images.

39. The method of claim 38, wherein said machine-readable instructions, if executed by said special purpose computing device, are further adapted to compare said one or more features of said captured image with one or more features of said plurality of stored images by transmitting at least a portion of said captured image to a location comprising a memory that stores said plurality of stored images, wherein said location is remote from said mobile device.

40. The method of claim 35, wherein said machine-readable instructions, if executed by said special purpose computing device, are further adapted to determine said approximate position of said handheld mobile device based, at least in part, on Near-Field Communication (NFC) signals, WiFi signals, Bluetooth signals, Ultra-Wideband (UWB) signals, Wide Area Network (WAN) signals, digital TV signals, and/or cell tower ID.

41. The method of claim 35, wherein said machine-readable instructions, if executed by said special purpose computing device, are further adapted to determine said approximate position of said handheld mobile device based, at least in part, on acquisition of one or more satellite positioning system signals at the mobile device.

42. The method of claim 35, wherein said machine-readable instructions, if executed by said special purpose computing device, are further adapted to determine said approximate position of said handheld mobile device based, at least in part, on user input.

43. The method of claim 35, wherein said machine-readable instructions, if executed by said special purpose computing device, are further adapted to:
detect an illuminated spot in said captured image of said target object produced by a light beam emitted from said mobile device; and
further determine an identity of said target object based, at least in part, on said detected illuminated spot.

44. The method of claim 35, wherein said machine-readable instructions, if executed by said special purpose computing device, are further adapted to:
direct a range-finding beam onto said target object;
measure a travel time of said range-finding beam;
determine a distance to said target object based, at least in part, on said travel time; and
further determine an identity of said target object based, at least in part, on said distance.

45. The method of claim 35, wherein said sensors comprise an accelerometer, magnetometer, compass, pressure sensor, and/or a gyro.
